(19) United States
(12) Patent Application Publication
(10) Pub. No.: US 2008/0023407 A1
(43) Pub. Date: Jan. 31, 2008

(54) Water Treatment Process

(75) Inventors: Bengt Goran Eriksson, Strathpine (AU); Stephen Ross Orpin, Kallangur (AU); Timothy Kevin Graham, Alexandra Hills (AU)

Correspondence Address: BECK AND TYSVER P.L.L.C., 2900 THOMAS AVENUE SOUTH, SUITE 100, MINNEAPOLIS, MN, 55416, US

(73) Assignee: Denis ANGELERI, Mt Eliza (AU)

(21) Appl. No.: 10/583,401

(22) PCT Filed: Dec. 17, 2004
(86) PCT No.: PCT/AU04/01773

§ 371 Date: Aug. 13, 2007

(30) Foreign Application Priority Data
Dec. 17, 2003 (AU) 2003906968

(51) Int. Cl. C02F 1/52

(52) U.S. Cl. 210/702; 210/709; 210/758; 210/721; 210/205; 210/96.1; 210/257.1; 210/220; 210/259; 210/748; 210/753

(57) ABSTRACT

A method of purifying water or wastewater that comprises the steps of adding a treatment agent to the water, passing the water through a mixing zone, and passing the water through a foam fractionation zone to provide purified water. The water or wastewater can be any type of water found in sewage pipes or any water discharged from domestic, commercial, industrial, agriculture or aquaculture (fresh or marine) processes, or groundwater, bore water and reservoir water. A system for purifying water, the system including a mixing zone comprising one or more mixing columns for mixing the water with a treatment agent and a foam fractionation zone for purifying the water, the foam fractionation zone in liquid communication with the mixing zone. A foam fractionation column comprising a column body, column base, a first water inlet located around the top of the column body, a second water inlet located in the column base and including gas injecting means for introducing gas into said second water inlet, a water outlet located in the column base, a foam formation zone located at the top of the fractionating column above the first water inlet; and a foam compression zone located above the foam formation zone comprising a frusto-conical section and a foam outlet; wherein the length of the column body is between 150-200% greater than the length of the column base; the diameter of the column base is at least 50% larger than the diameter of the column body; and the base and body of the column are interconnected by a frusto-conical section, the edges of the frusto-conical section sloped at 45-80 degrees.

### FIELD OF INVENTION

The present invention generally relates to treatment of water. In particular, the invention relates to the purification of wastewater including sewage.

### BACKGROUND OF THE INVENTION

Water is an invaluable commodity and most regions of the world are faced with a limited and declining resource of fresh, consumable water due to diminishing water sources and tables, population growth, increasing industrialization, increasing agricultural activity and use of irrigation, and pollution of fresh water supplies. Therefore treatment of sewage, wastewater and ground water are becoming of increased importance worldwide and in areas where water is at a premium, such as highly populated areas and/or regions that have very little rainfall, water recycling is essential.

In the developed world water restrictions are frequently imposed on domestic users and commercial institutions by governments. In situations of water shortage the water supply may only be available for one to two hours a day and non-essential use of water for swimming pools, and watering plants, golf courses and parks maybe banned. Even if sources of fresh water are readily available, water conservation and recycling or reclaiming are ecologically and environmentally preferred options.

Reclaimed waters can serve as an invaluable supplemental source of water for use in industry (building and cooling), washing, fire prevention, agriculture and use in water fountains and pools. One particular use for reclaimed water is the irrigation of crops, resorts, parks and golf courses and general landscaping, which constitute approximately two thirds of total water demand. However, despite the wide range of uses for non-potable reclaimed water, water reclamation is rarely practiced. This may be due to a lack of efficient and cost effective treatment processes and also to problems in accessing, distributing and transferring the treated reclaimed water to the sites of use.

A number of processes have heretofore been developed for treating sewage, wastewater and groundwater to obtain potable and non-potable water of varying quality. Such processes include the use of chemical treatment and physical treatment systems. In a municipal sewage treatment plant system both the solid and liquid components of sewage are treated using the processes of clarification, aeration and disinfection. The main additives in the treatment process are oxygen or air for biodegradation of organic materials in the sewage and electrical power to operate pumps and compressors that deliver and mix the oxygen or air. The purified sewage effluent is either recycled or discharged into the ocean or waterways and the solid sludge waste is disposed.

Raw sewage mining for water reclamation accesses raw sewage water from a municipal sewage pipe, treats and purifies the sewage water, returns the waste products to the municipal sewage pipe and the purified potable or non-potable water is recycled for human use. A useful raw sewage treatment process should provide consistent output of a specified quality and must be cost effective to run.

Conventional treatment of sewage waters involve treating the wastewater with an oxidizer, such as ozone or chlorine, solid separation in large open concrete vessels with long retention times, and filtration of the wastewater using filtration or membrane microfiltration. The conventional systems have a large footprint (i.e. they require a large amount of space), a slow wastewater flow rate through the system and have to be constantly treated for inevitable breakouts of undesirable bacteria and microorganisms. In addition to pathogenic impurities, incoming wastewater can comprise hard and abrasive materials, such as stones, that can damage components of the treatment system and floatable materials, such as oils, greases and fibers that can block a physical treatment system. The conventional systems are also expensive to run and maintain, and have limited contaminant removal ranges requiring specific equipment for specific contaminants. As a result, very few of the processes have been converted to practice and used for water reclamation on a large scale either because of unsatisfactory contaminant removal efficiency and/or high costs associated with the implementation of the process technology.

Dissolved Air Floatation (DAF) systems are typically end-of-line process systems that treat sewage that contains heavy particulate solids. DAF systems are typically large, not portable and are dependant on mechanical devices to remove sludge and foam. Such DAF systems comprise a chamber into which dissolved compressed air is passed through the wastewater to remove contaminants in a foam. The point at which the foam meets the water (foam water interface height) and therefore the foam wetness can not be varied in a DAF system which reduces the flexibility of the system in removing a wide variety of contaminants. DAF systems have a slow treatment rate, are not suitable for treating large volumes of water in confined spaces and are expensive to operate and maintain.

U.S. Pat. Nos. 6,641,721 and 6,488,853, in the name of Mullerheim, describe a wastewater reclamation process and apparatus that comprise a settleable solids separator and a gas floatation separation system. The wastewater can be obtained from a sewer. The solids separator, such as a vortex separator, separates settleable solids and floatable material from the wastewater prior to treatment of the wastewater by the gas floatation system which passes bubbles of gas through the wastewater producing a reusable liquid effluent and a froth component. Due to the solids separation and retention step this process can only be used as a batch process and not as a continuous treatment process and consequently would not cope with high volumes of wastewater at high velocity.

It is therefore an object of the invention to provide a process that may alleviate the disadvantages of the prior art.

### SUMMARY OF INVENTION

In a first aspect, the invention provides a method of purifying water, the method comprising the steps of:

(i) adding a treatment agent to the water;

(ii) passing the water through a mixing zone; and

(iii) passing the water through a foam fractionation zone to provide purified water.

where steps (i) and (ii) may precede and/or follow step (iii).

Suitably, a foaming agent is added prior to step (iii).

Prior to step (iii) the water maybe passed through a flocculation zone wherein the water may remain in the flocculation zone for 2-15 minutes. More preferably, the water remains in the flocculation zone for 4-7 minutes. A flocculent may be added to the water prior to passing the water through the flocculation zone.

Preferably, the pH of the water is adjusted so it falls within the range 6.5-8.5 pH. More preferably, the pH of the water falls within the range 6.5-7.5 pH.

The mixing zone may comprise one or more mixing columns where the water is in contact with the treatment agent for 2-6 minutes before the water passes into the foam fractionation zone. The treatment agent may be selected from the group consisting of oxidizing, anti-microbial and flocculating agents.

Suitably, the water undergoes a second pass through the foam fractionation zone.

In a second aspect, the invention provides a system for purifying water that comprises:

(i) a mixing zone for mixing the water with a treatment agent; and

(ii) a foam fractionation zone for purifying the water,

wherein the foam fractionation zone is in liquid communication with the mixing zone.

Preferably, the foam fractionation zone of the system includes a foam fractionation column and a foam height adjustment valve or assembly for varying the level of water within the foam fractionation column.

Preferably, the foam fractionation column of the system comprises:

(i) a column body;

(ii) a column base;

(iii) a first water inlet located around the top of the column body;

(iv) a second water inlet located in the column base and including a gas injecting means for introducing gas into said second water inlet;

(v) a water outlet located in the column base;

(vi) a foam formation zone located at the top of the fractionating column above the first water inlet; and

(vii) a foam compression zone located above the formation zone comprising a frusto-conical section and a foam outlet;

wherein the length of the column body is between 150-200% greater than the length of the column base; the diameter of the column base is at least 50% larger than the diameter of the column body and the base and body of the column are interconnected by a frusto-conical section, the edges of the frusto-conical section sloped at 45-80 degrees.

Preferably, the edges of the frusto-conical section are sloped at around 60 degrees.

The foam fractionation column of the system may also include a foam removal apparatus, the foam removal apparatus comprising:

(i) a discharge conduit in communication with the foam outlet of the foam fractionation column;

(ii) a spray nozzle housed within the conduit, the spray nozzle in liquid communication with a motive flow source; and

(iii) at least one or more air pathways located in the conduit to provide communication between external air and an internal space of the conduit.

Preferably, the valve assembly or foam height adjustment valve comprises:

(i) a housing with a central bore positioned in the housing;

(ii) one or more bushes positioned in the housing;

(iii) a valve stem threadably engaged with the bushes;

(iv) a handle located at a proximal end of the stem;

(v) a valve located at a distal end of the stem; and

(vi) a least one or more air pathways located in the bushes and adapted to provide communication between external air and an internal space of a conduit to which the valve assembly is attached.

Preferably, the one or bushes are positioned so they are spaced apart.

Suitably, the system includes a flocculating column.

The system may also include a pH sensor and pH adjustment means.

Preferably, the system includes one or more treatment injection means.

The system may also include one or more storage tanks.

In a third aspect, the invention provides a foam fractionation column, the foam fractionation column comprising:

(i) a column body;

(ii) a column base;

(iii) a first water inlet located around the top of the column body;

(iv) a second water inlet located in the column base and including a gas injecting means for introducing gas into said second water inlet;

(v) a water outlet located in the column base;

(vi) a foam formation zone located at the top of the fractionating column above the first water inlet; and

(vii) a foam compression zone located above the formation zone comprising a frusto-conical section and a foam outlet;

wherein the length of the column body is between 150-200% greater than the length of the column base; the diameter of the column base is at least 50% larger than the diameter of the column body and the base and body of the column are interconnected by a frusto-conical section, the edges of the frusto-conical section sloped at 45-80 degrees.

Preferably, the edges of the frusto-conical section are sloped at around 60 degrees.

The foam fractionation column may also include a foam removal apparatus, the foam removal apparatus comprising:

(i) a discharge conduit in communication with the foam outlet of the foam fractionation column;

(ii) a spray nozzle housed within the conduit, the spray nozzle in liquid communication with a motive flow source; and

(iii) at least one or more air pathways located in the conduit to provide communication between external air and an internal space of the conduit.

In a fourth aspect, the invention provides a valve assembly for varying the level of water within a foam fractionation column, the valve assembly comprising:

(i) a housing with a central bore positioned in the housing;

(ii) one or more bushes positioned in the housing;

(iii) a valve stem threadably engaged with the bushes;

(iv) a handle located at a proximal end of the stem;

(v) a valve located at a distal end of the stem; and

(vi) a least one or more air pathways located in the bushes and adapted to provide communication between external air and an internal space of a conduit to which the valve assembly is attached.

Preferably, the valve assembly comprises two spaced bushes.

Throughout this specification, “comprise”, “comprises” and “comprising” are used inclusively rather than exclusively, will be understood to imply the inclusion of a stated integer or group of integers but not the exclusion of any other integer or group of integers.

### BRIEF DESCRIPTION OF THE DRAWINGS

Reference may now be made to preferred embodiments of the invention as shown in the attached drawings wherein:

FIG. 1: A schematic view of a water treatment system comprising oxidation, flocculating and foam fractionation zones.

FIG. 2: A schematic view of a water treatment system showing an alternative method of water treatment.

FIG. 3: A schematic view of a water treatment system showing a further alternative method of water treatment.

FIG. 4: A view of a foam fractionating column assembly.

FIG. 5: A view of a foam height adjustment valve.

FIG. 6: A view of a foam discharge zone of the foam fractionating column assembly.

### DETAILED DESCRIPTION OF INVENTION

For the purposes of this invention, by “water” or “wastewater” is meant any type of water found in sewage pipes or any water discharged from domestic, commercial, industrial, agricultural or aquaculture (fresh or marine) processes, or groundwater, bore water and reservoir water.

The water can contain contaminants such as, organic substances, such as nitrates, proteins, fatty acids, polysaccharides and phospholipids, larger biological material, such as bacteria, viruses and algae, colloidal material, inorganic matter, leachates, metal ions, colour and particles.

The present invention provides a continuous or batch treatment process for the treatment of water that comprises a foam fractionation system, also termed a particulates air separation system, and can be used for but is not limited to:

(i) the removal of manganese or iron compounds;

(ii) the removal of leachates (inclusive of metal ions and soil contaminants);

(iii) the production of class “A” or “B” irrigation water from wastewater obtained from raw sewage mining;

(iv) the production of class “A” irrigation water from class “B” irrigation water (as defined in the South Australian Reclaimed Water Guidelines and the Queensland Guidelines for the safe use of recycled water);

(v) the removal or partial removal of nitrates, proteins, fatty acids, polysaccharides and phospholipids;

(vi) the removal or partial removal of biological material inclusive of bacteria, viruses and algae;

(vii) the removal or partial removal of colloidal material; and

(viii) the removal or partial removal of inorganic matter.

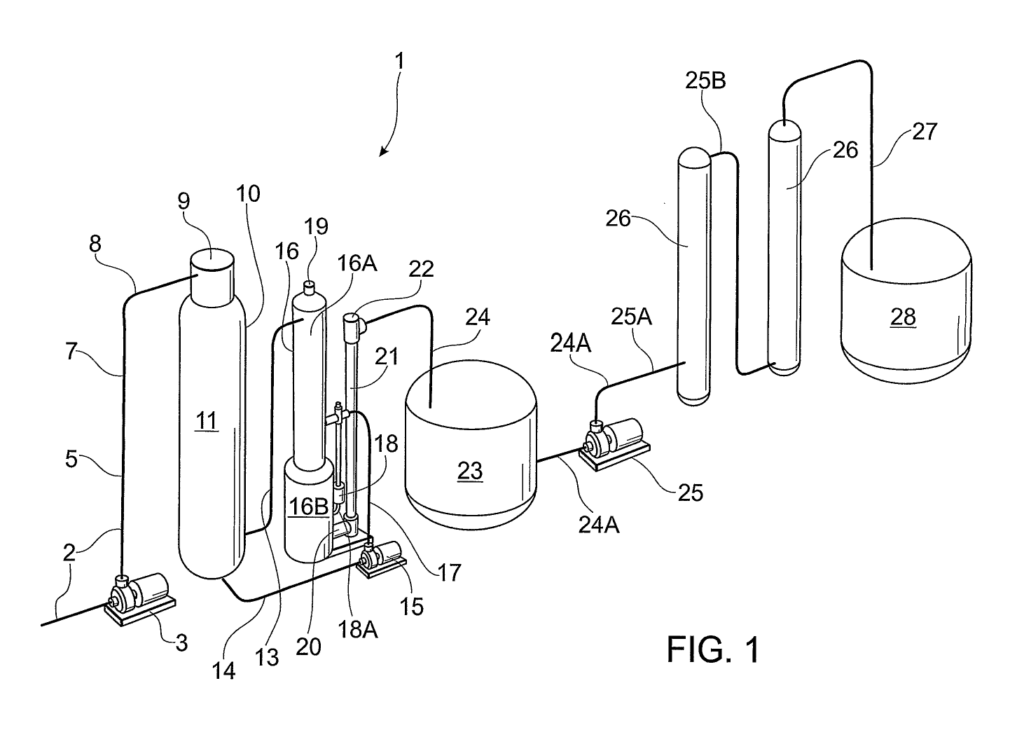

FIG. 1 shows a schematic drawing of water treatment system 1 which maybe applied to water obtained from raw sewage mining from municipal sewage pipes.

The water may be obtained directly from municipal sewage pipelines (a process known as raw sewage mining), from domestic households, or from sewage treatment plants. If the water is obtained by raw sewage mining, care is taken to ensure that only a water liquid stream comprising a minimal amount of solids is removed from the pipeline.

Water or raw sewage is supplied through conduit 2 by a raw water supply pump 3 or other motive flow source. An optional pH sensor (not shown) may be located in conduit 2 at point 5 intermediate to pump 3 and flocculating column 10 to measure the pH of the water on a continuous basis using an automated controller or microprocessor.

If the pH of the water is greater than 8.5, an acid solution may be added to conduit 2. Preferably, the acid solution is a mineral acid, such as sulphuric or hydrochloric acid.

If the pH of the water is less than 6.5, alkali solution maybe added to conduit 2. Preferably, the alkali solution is sodium hydroxide, sodium bicarbonate or potassium hydroxide, or an alkaline earth species such as calcium hydroxide or lime.

The pH adjustment maintains the pH and/or carbonate hardness within the desired range for flocculation, oxidation and foam fractionation, and the pH can be adjusted to fall within any desired range. Preferably, the pH falls within the range 6.5-7.5.

A treatment agent, such as an oxidizing agent and/or an anti-microbial agent, may be added to the water at point 7 prior to passage through mixing or flocculation column 10. It will be appreciated that the oxidizing agent and/or anti-microbial agent may also be added to the water at point 25A discussed hereinafter. Suitable oxidising agents may include chlorine, ozone, bromine, PROXITANE (3-5.4% peroxyacetic acid, 20-24% H₂O₂, 10-12% acetic acid and water), peroxyacetic acid, peracyclic acid, perchlorate and hydrogen peroxide. Suitable anti-microbial agents include ultra violet light, iodine and chlorine.

The water is passed into flocculating column 10 which may comprise static mixers or an agitator in the form of a rotatable paddle to agglomerate any solid particles in the water and to accelerate gravity separation of the solid particles.

Flocculants or thickening agents may be injected into conduit 2 at point 8.

Preferably, the thickening agents or flocculants may be selected from the group consisting of alum sulphate, polyaluminium chloride, ferric sulphate, ferric chloride and inorganic salt-polymer blends.

The flocculant mixes with the water in flocculant mixing zone 9 which preferably comprises a static mixer. The water then passes into the flocculating column reaction zone 11.

The water is transferred to foam fractionating column 16 through conduits 13 and 14.

Water transferred to column 16 via conduit 13 enters upper region 16A of column body 16A. Water transferred to column 16 via conduit 14 passes through pump or motive flow source 15, conduit 17, venturi 18, venturi conduit 18A and enters base 16B of column 16 through a gas diffuser or venturi nozzle 18C (not shown). Venturi 18, which can also be an injector or eductor, provides resistance to water flow thereby sucking air into the water. A foaming agent or surfactant may be used to increase the foaming ability of the water, the generation of consistent suitably sized bubbles and to manipulate the foam wetness. Foaming agents usually comprise polymeric materials. Suitable foaming agents may include any anionic, cationic, amphoteric and non-ionic surfactant as described hereinafter, such as anionic sulfonate, anionic sulphates, ether sulphates, sodium lauryl sulphate, AMPHOLYTE (amphoteric surfactant), proteins such as albumin, and yeast. The foaming agent may be added to the water prior to flocculation (at point 8) or added directly to fractionating column 16.

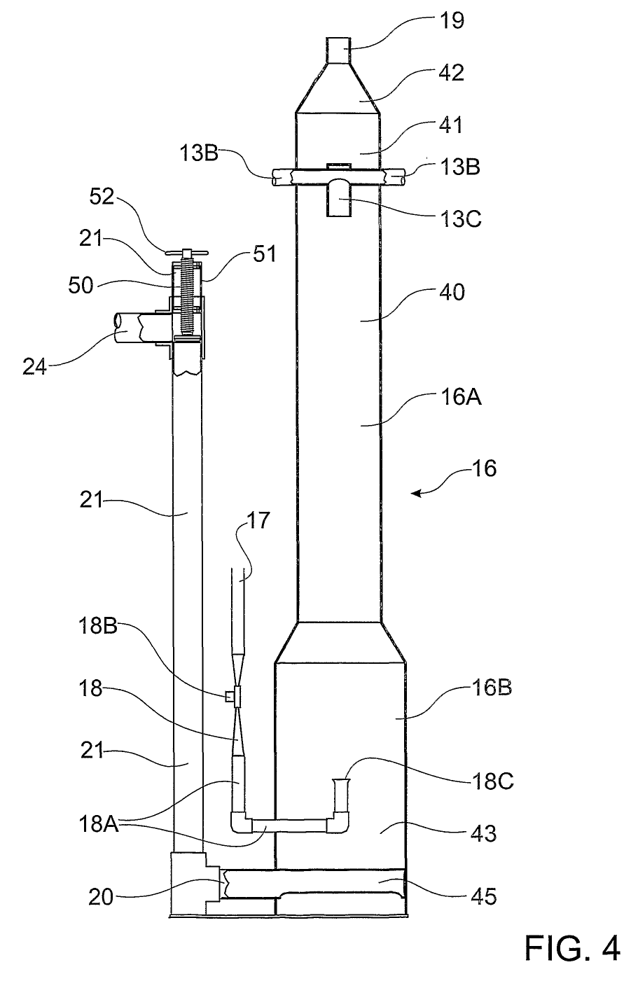

The water undergoes foam fractionation or particulates air separation (also known as protein skimming) in fractionating column 16. Fractionating column 16 (FIG. 4) comprises column body 16A, column base 16B, first water inlet 13B, foam outlet 19, water outlet 20 and second water inlet or venturi nozzle 18C. The venturi system or an efficient, effective air diffuser, or air injecting means, draws in (through venturi gas inlet 18B) and diffuses a gas, such as air, ozone or gaseous chlorine with the water and generates a swarm of small bubbles which rise up the fractionating column through the water, adsorbing dissolved and particulate contaminant molecules. The bubbles form stable foam at the top of the fractionating column and the foam comprising the contaminants is discharged through foam outlet 19. Fractionating column 16 will be described in detail in FIG. 4 hereinafter.

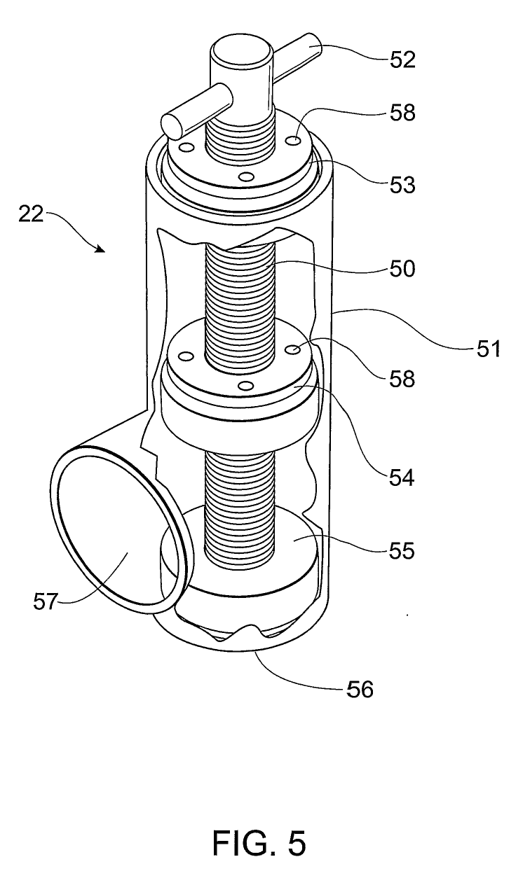

The treated water effluent is discharged through column base 16B through water outlet 20 and is transferred to foam height adjustment valve 22 through conduit 21. Valve 22 (FIG. 5) provides resistance to water flow into storage tank 23 through conduit 24 and therefore controls the position of the water level, or foam/water interface and resultant foam height which alters the foam wetness, as described hereinafter. Preferably, storage tank 23 is open to the atmosphere.

The water is transferred from storage tank 23 to mixing columns 26 through conduit 24A and pump or motive flow source 25. Preferably, the water is retained within each mixing column for 1-3 minutes. An oxidising and/or anti-microbial agent is injected into conduit 24 at point 25A. An oxidizing and/or anti-microbial agent can also be injected at point 25B in between mixing columns 26. If there are a plurality of mixing columns oxidising and/or anti-microbial agents can be injected in between each column.

After oxidation/anti-microbial treatment the water is discharged through conduit 27 into collection tank 28. The purified water can then be transported to a site of use, or if plant 1 is being used on site the purified water can be transferred directly from collection tank 28 to, for example, plants, grass or crops to be watered. The purified water can also be transferred into conduit 2 or fractionating column 16 for a second pass through the flocculating zone and/or the foam fractionation zone (not shown).

Preferably, the sludge and foam waste produced by the flocculating and foam fractionating steps, respectively, is discharged back into the municipal sewage pipeline or a drying bed or similar device. However, it will be appreciated that the sludge can be disposed of in a variety of ways.

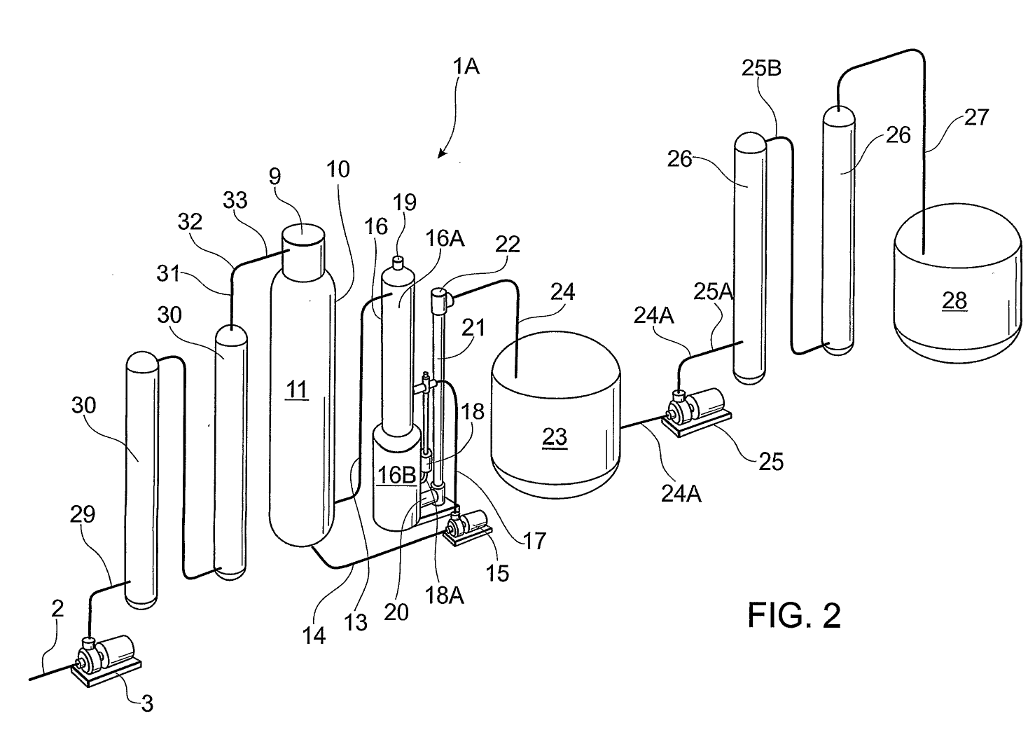

FIG. 2 shows a schematic drawing of an alternative embodiment of water treatment system (1A) which may be applied to bore water or groundwater or to water obtained from raw sewage mining from municipal sewage pipes, treated sewage pipelines or reservoirs, abattoirs, diary factories and plant nurseries.

Water or raw sewage is supplied through conduit 2 by raw water supply pump or motive flow source 3 to mixing columns 30. Preferably, the water is retained within each mixing column for 1-3 minutes. An oxidising and/or anti-microbial agent is injected into conduit 2 at point 29.

The water is discharged through conduit 31. A pH sensor may be located in conduit 31 at point 32 to measure the pH of the water on a continuous basis using an automated controller or microprocessor.

If the pH of the water is greater than 8.0 an acid solution may be added to conduit 31.

If the pH of the water is less than 7.0, alkali solution may be added to conduit 31.

A flocculating agent is injected into conduit 31 at point 33.

The water is passed into flocculating column 10 as described above.

The water is transferred to foam fractionating column 16 through conduits 13 and 14, as described above. A foaming agent can be added to the water prior to flocculation (at point 33) or added directly to fractionating column 16.

The water undergoes foam fractionation in fractionating column 16 and is passed through mixing columns 26 as described above.

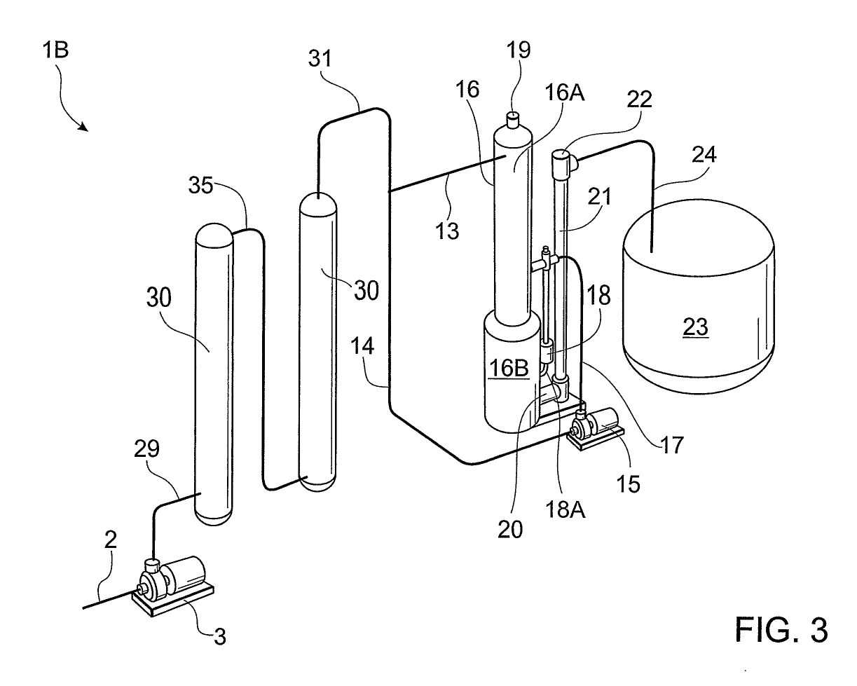

FIG. 3 shows a schematic drawing of a further alternative embodiment of water treatment system (1B) which maybe applied to water comprising iron species contaminants.

Water is supplied through conduit 2 by raw water supply pump or motive flow source 3 to mixing columns 30. An oxidising and/or anti-microbial agent is injected into conduit 2 at point 29. An oxidizing and/or anti-microbial agent may also be injected at point 35.

The water is discharged through conduit 31 and transferred to foam fractionating column 16 through conduits 13 and 14. Foam fractionation is carried out as described for FIGS. 1 and 2 and purified water is discharged through water outlet 20, foam height adjustment valve 22 and conduit 21 to storage tank 23.

One or a plurality of mixing columns (30) can be used in the process. If the water comprises high levels of microbial contaminants, multiple oxidising and/or anti-microbial agents and multiple mixing columns may be required. Preferably, steps (a) and (b) of the process are carried out after steps (c) and (d) when a large proportion of the contaminants have been removed by foam fractionation and therefore less chemicals are required.

Preferably, the water is passed through the mixing columns from the bottom of the columns to the top which prevents air or gas from interfering with water flow.

The invention also includes within its scope a novel fractionation column assembly as shown in FIG. 4 and a novel valve assembly as shown in FIG. 5.

Fractionating column 16 has a number of distinctive zones (FIG. 4) including reaction zone 40, where the water and gas mix and react, foam formation zone 41, where the foam is allowed to stablise and build, foam compression zone 42, where the foam collects and the foam wetness or dryness is controlled, and separation zone 43, where the gas and water are allowed to separate. Venturi nozzle 18C is located in column base 16B and orientated so that the nozzle outlet faces upwards. Conduit inlet nozzle 13C, located at the top of column body 16A and below foam formation zone 41, is orientated so that the nozzle outlet faces downwards.

Preferably, foam formation zone 41, where the foam is allowed to stablise and build, is non-agitated by the in-coming water through conduit inlet 13B and nozzle 13C.

Foam fractionation or particulates air separation predominantly removes surfactant contaminant molecules (molecules that have polar and non-polar ends). At the air-water interface of the bubbles the surfactant molecules orientate themselves so that the non-polar hydrophobic end of the surfactant molecules is in air and the polar hydrophilic end of the molecule is in water. As the bubbles rise to the top of the fractionating column they remove the contaminants and settle at the top of the column as a foam.

Many organic substances can be removed by foam fractionation and larger biological material, such as algae, bacteria, flocs and viruses can also be removed. Particles present in the water can also be removed. It is thought that biological material and particles become trapped in the film surrounding the air bubbles. Inorganic material can also be removed if it can form some kind of a bond with organic matter in the water. For example, calcium carbonate and calcium phosphate complexes can collect organic matter in the water forming micro-flocs that can get trapped in the film surrounding the air bubbles. Metal ions can also form ligands with organic molecules, and glycoproteins have a high affinity for trace metals and therefore facilitate removal of metal ion species from water.

Efficient contaminant removal may be dependent on at least one of the following factors:

(i) air to water ratio;

(ii) column height;

(iii) air bubble diameter;

(iv) air/water contact time;

(v) air bubble flow rate;

(vi) foaming agent;

(vii) foam wetness;

(viii) downward water flow rate;

(ix) foam stability; and

(x) collision speed between the water and the rising gas.

Bubble size is an important factor. Smaller diameter bubbles result in a higher total surface area of the bubble swarm which facilitates more efficient adsorption of the water contaminants. Smaller bubbles also rise up the fractionating column more slowly, allowing more contact time with the water.

Preferably, the diameter of the bubbles falls within the range 0.5-3.0 mm.

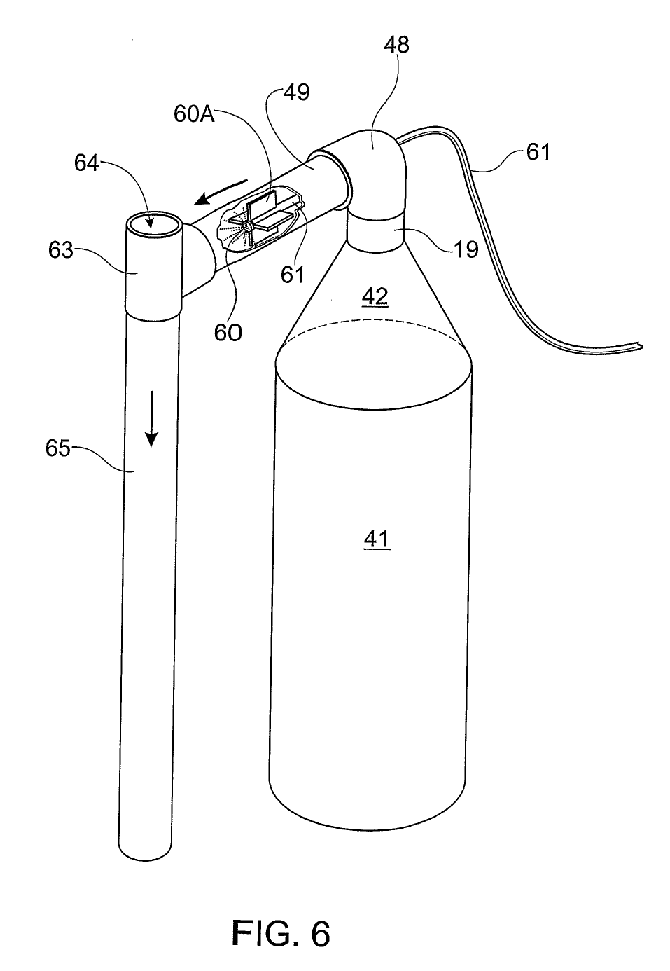

Foam stability may also be an important factor and can be defined as the resistance to contaminant drainage from the foam, without foam rupturing. The foam must be stable enough to be removed from the fractionating column, without leaching of the contaminant molecules into the water occurring. Preferably, the foam is removed immediately from the fractionating column. Foam removal is described hereinafter in relation to FIG. 6.

Foam wetness (the amount of water contained with the foam) can be varied by varying the foam/water interface position, or the level of water, in fractionating column 16. A wet foam which removes and retains more contaminants is preferred. Foam height adjustment valve, or valve assembly 22 (FIG. 5) controls the position of the foam/water interface. Valve 22 comprises valve stem 50, valve housing 51, handle 52, upper bush 53, lower bush 54, valve or valve member 55, water inlet 56 and water outlet 57. Handle 52 is located at a proximal end of the stem and valve member 55 is located at a distal end of the stem. Upper and lower bush 53 and 54 provide support for the valve assembly and are threadably engaged with the stem. Upper and lower bush 53 and 54 may comprise one or more air pathways 58. The air pathways provide communication between external air and an internal space of conduit 21 (to which valve assembly 22 is attached), which prevents siphoning of water within the conduit.

The resistance to water flow can be altered by adjusting the position of valve member 55 using handle 52. If the valve is partially closed by lowering valve member 55, resistance to water flow through valve 22 from water inlet 56 to water outlet 57 is increased. The position of the foam/water interface rises up fractionating column 16 resulting in a shorter column of foam and therefore a wetter foam.

If the valve is opened by raising valve member 55, resistance to water flow through valve 22 from water inlet 56 to water outlet 57 is decreased. The position of the foam/water interface falls down fractionating column 16 resulting in a longer column area of foam and therefore a dryer foam. If valve 22 is closed by lowering valve member 55 water flow through the valve is prevented and water will exit water treatment system 1 through foam outlet 19. Closure of valve 22 can be used to flush fractionating column 16 to remove dirty foam from the inside of the column.

In one form, operation of foam height adjustment valve 22 maybe carried out automatically and therefore the foam/water interface can be regulated automatically. This may be carried out by actuating the valve with a suitable drive motor, such as a DC drive motor, a pressure transducer and electronic logic control.

FIG. 6 shows a preferred foam removal apparatus of fractionating column 16 which facilitates the immediate removal of the produced foam from the column. The foam collected in foam compression zone 42 is removed from column 16 through foam outlet 19 and conduits 48 and 49. Conduit 49 comprises spray nozzle 60 which is connected via hose 61 to a motive flow source, such as venturi 18. Conduit 49 is connected to discharge conduit 65 via T-junction 63. Spray nozzle 60 has radially extending ribs 60A which retain spray nozzle 60 in a location around the centre of conduit 49.

Foam building up in foam compression zone 42 enters foam outlet 19 and conduit 49. Liquid passes through hose 61 into conduit 49 through spray nozzle 60. The atomised liquid dissolves the foam into a liquid and facilitates movement of the foam through conduit 49 into discharge foam conduit 65. T-junction 63 is open to the atmosphere 64, through one or more air pathways, to prevent siphoning of the water within the foam fractionation column 16 through discharge conduit 65.

It will be appreciated by a person skilled in the art, that use of different foaming agents may be required for waters comprising different chemical compositions. For example, cationic surfactants, such as aliphatic mono-, di- and polyamines, and 2-alkyl-1-(2-hydroxyethyl)-2-imidazolines, may be suitable for acidic waters. Anionic surfactants, such as carboxylates, sulphates, sulphonates and acylated protein hydrolysates, may be suitable for alkaline wastewaters. Non-ionic surfactants, such as carboxylic acid esters and amides, and polyalkylene oxide block copolymers, have no discrete charge when dissolved in aqueous media and may be suitable for acidic, neutral and alkaline waters. Amphoteric surfactants, such as imidazolinium derivatives, comprise both an acidic and a basic hydrophilic group and may be suitable for acidic, neutral and alkaline waters.

Foam fractionating column 16 has been specifically designed for this water process to have a predicted downward water flow rate (and therefore velocity).

Preferably, the introduced diffused gas to water ratio falls within the range of 20% to 50%.

Preferably, foam outlet 19 has a frusto-conical shape facilitating foam discharge out of fractionating column 16.

Preferably, the rate of flow of water through the column falls within the range 1000 1 /min² (0.034 m/sec) to 3400 1/min/² (0.057 m/sec).

More preferably, the rate of flow is 2700 1 /min/² (0.045 m/sec).

Preferably, water is not retained within column body 16A for more than 30 seconds.

Preferably, base 16B of the column does not have a rate of water flow greater than 1200 1 /min/m² (0.02 m/sec).

Preferably, the length of column body 16A is at least 180% greater in length than column base 16B. More preferably, the length of column body 16A is at least 150-200% greater in length than base 16B.

Preferably, the diameter of base 16B is at least 50% larger than the diameter of column body 16A.

Preferably, the total retention time of the water in column 16 falls within the range 75-200 seconds for all columns with a diameter of less than 2000 mm.

Preferably, the interconnection between the stepped base 16B and the body column 16A comprises a frusto-conical section. Preferably, the edges of the frusto-conical section are sloped at 45-80 degrees. More preferably, the edges are sloped at around 60 degrees.

Preferably, the distance of foam compression zone 42 from water inlet 13B falls within the range 200-500 mm.

Preferably, the inlet nozzle 13C is orientated downwards so water is discharged down column 16. Preferably, the introduced gas through venturi conduit 18A has a volume greater than 20% of the total volume of water passing through outlet conduit 21.

More preferably, the volume of gas introduced through venturi conduit 18A falls within the range of 25-50% of the total volume of water passing through outlet conduit 21.

Preferably, foam formation zone 41 has a cross-sectional area which is 1.5-3.5 times greater in area than inlet 13B.

More preferably, foam formation zone 41 has a cross sectional area twice the size of the area of inlet 13B.

Preferably, foam compression zone 42 comprises a frusto-conical section located at the top of fractionating column 16.

Preferably, the velocity of water passing through water outlet 20 is less than 0.5 m/sec.

Preferably, water outlet 20 is located in base 16B and has a sparge arrangement 45, whereby the water access ports face downwards towards the floor of base 16B to prevent air bubbles accessing water outlet 20.

The power system controlling water treatment systems 1, 1A and 1B maybe automated to facilitate precise control and to provide flexibility in controlling the foam fractionation process.

Preferably, water treatment systems 1, 1A and 1B are designed to be compact and portable to facilitate transport to and use in developed areas and areas of confined space.

Preferably, the systems can be mounted on ground engaging wheels or a skid. There also may be provided a generator (electrical or solar) for providing electrical power to the system.

Modifications may be made to the water treatment process. The order of the treatment steps may be modified subject to the nature or composition of the water. Prior to treatment of water using systems 1, 1A and 1B, the water maybe analysed to assess the composition of the water and the nature of suspended solids, if present.

Additional or modified process steps may be required when treating water comprising other contaminants, to contend with differing chemical properties of the contaminants. Different flocculating, foaming and oxidising agents may be utilised. Suitable pre-treatment steps may be required for effective contaminant removal, such as solid separation using a hydrocyclone or centrifuge. Post-treatment steps such as ultraviolet treatment may also be carried out.

So that the invention may be more readily understood and put into practical effect, the skilled person is referred to the following non-limiting examples.

### EXAMPLES

### Example 1

Raw water (bore water) contained 14 mg/L of iron, had a pH of 6.8 and conductivity of 1.7 mS/cm

Water treatment system 1B as shown in FIG. 3 was used. The water was oxidised with sodium hypochlorite for 2 minutes before passing through fractionating column 16. A non-ionic foaming agent was used. The rate of flow through the water purification system was 2000 L/hr.

### Results

The foam wetness was firm. The oxidized iron was readily visible in the discharged foam waste. The pH of the purified water was 6.8 and conductivity was unchanged at 1.7 mS/cm. The amount of iron remaining in the purified water was 0.18 mg/L.

The water loss or wastage was approximately 0.1% of the total volume of water passing through the system.

### Example 2

Raw water (treated, non-chlorinated, sewage) contained approx 8000 Faecal Coliforms/100 ml. Water treatment system 1B as shown in FIG. 3 was used. The water was oxidised with ozone for 2 minutes before passing through fractionating column 16. A non-ionic foaming agent was used. The rate of flow through the water purification system was 5000 L/hr.

### Results

The foam was firm. The treated water was visibly cleaner and less coloured, the Faecal Coliform count was approx 80/100 ml in the treated water stream.

The water loss or wastage was approximately 0.1% of the total volume of water passing through the system.

### Example 3

Raw water (treated sewage of approx class “C”) contained approximately 320/100 ml Faecal Coliforms. Water treatment system 1B as shown in FIG. 3 was used. The water was oxidised with sodium hypochlorite for 6 minutes before passing through fractionating column 16. An ozone/air mix was introduced into the second water inlet via the foam fractionation venturi. A non-ionic foaming agent was used. The rate of flow through the water purification system was 5000 L/hr.

### Results

The foam wetness was firm. The treated water was visibly cleaner and had significantly less colour. The Faecal Coliform count was<1/100 ml in the treated water stream. Turbidity was reduced from 2.1 NTU to 1.6 NTU.

The water loss or wastage was approximately 0.1% of the total volume of water passing through the system.

### Example 4

Raw sea water (Marine Aquaculture Hatchery) had a total plate count of 34000/100 ml. Water treatment system 1B as shown in FIG. 3 was used. The water was oxidized with ozone for 6 minutes before passing through fractionating column 16. An ozone/air mix was introduced into the second water inlet via the foam fractionation venture. The rate of flow through the water purification system was approximately 22,000 L/hr.

### Results

The foam wetness was firm. The treated water was visibly cleaner and clearer. The total plate count was<1/100 ml in the treated water stream.

The water loss or wastage was approximately 0.1% of the total volume of water passing through the system.

The advantages of the water treatment system of this invention are as follows:

(i) the process allows the rapid treatment of large volumes of water and can treat effectively 2000-3400 L/min/m²;

(ii) the system carries out a continuous and instant separation and removal of unwanted material from the water;

(iii) the system can be automated, compact and portable;

(iv) the system has a small foot print in comparison to conventional water treatment systems rendering it very practical for use in highly developed areas where space is scarce and land is at a premium;

(v) the system comprises no media, membranes, screens, barriers or the like which require constant cleaning, replacement and treatment for undesirable bacteria;

(vi) the system comprises no moving parts and therefore is less complex, easy to clean and easy to operate;

(vii) the process can perform effectively the simultaneous removal of multiple contaminants;

(viii) water wastage is negligible and can be as little as 0.05% of the total volume of water passing through the system; and

(ix) the process is cost effective, the costs of running the system being a fraction of the cost of running conventional systems.

1. A method of purifying water, the method comprising the steps of:
(i) adding a treatment agent to the water;
(ii) passing the water through a mixing zone; and
(iii) passing the water through a foam fractionation zone to provide purified water.

2. The method of claim 1 wherein steps (i) and (ii) precede step (iii).

3. The method of claim 1 wherein steps (i) and (ii) both precede and follow step (iii).

4. The method of claim 1 wherein a foaming agent is added prior to step (iii).

5. The method of claim I wherein the water is passed through a flocculation zone prior to step (iii).

6. The method of claim 5 wherein the water remains in the flocculation zone for 2-15 minutes.

7. The method of claim 6 wherein the water remains in the flocculation zone for 4-7 minutes.

8. The method of claim 5 wherein a flocculant is added to the water prior to passing the water through the flocculation zone.

9. The method of claim 1 including the step of ensuring the pH of the water falls within the range 6.5-8.5 pH.

10. The method of claim 9 including the step of ensuring the pH of the water falls within the range 6.5-7.5 pH.

11. The method of claim 1 wherein the mixing zone comprises one or more mixing columns.

12. The method of claim 11 wherein the water is in contact with the treatment agent for 2-6 minutes before the water is passed into the foam fractionation zone.

13. The method of claim 1 wherein the treatment agent is selected from the group consisting of oxidizing, anti-microbial and flocculating agents.

14. The method of claim 13 wherein the oxidising agent is selected from the group consisting of chlorine, bromine, ozone, peroxyacetic acid and hydrogen peroxide.

15. The method of claim 13 wherein the anti-microbial agent is selected from the group consisting of ultra violet light, chlorine and iodine.

16. The method of claim 13 wherein the flocculating agent is selected from the group consisting of alum sulphate, polyaluminium chloride, ferric sulphate, ferric chloride and inorganic salt-polymer blends.

17. The method of claim 1 wherein the foam fractionation zone comprises a fractionation column.

18. The method of claim 17 wherein the rate of flow of water through the fractionation column falls within the range 1000-3400 L/min/m².

19. The method of claim 18 wherein the rate of flow falls within the range 2600-2800 L/min/m².

20. The method of claim 17 wherein water enters the fractionation column through a first water inlet located around the top of the column and a second water inlet comprising a gas injection means located around a base of the column.

21. The method of claim 20 wherein gas injected into the second water inlet falls within the range of 20-50% of the total water flow through the second water inlet.

22. The method of claim 1 wherein the water undergoes a second pass through the foam fractionation zone.

23. A system for purifying water, the system including a mixing zone comprising one or more mixing columns for mixing the water with a treatment agent and a foam fractionation zone for purifying the water, the foam fractionation zone in liquid communication with the mixing zone.

24. The system of claim 23 wherein the foam fractionation zone includes a foam fractionation column.

25. The system of claim 23 and claim 24 wherein the foam fractionation zone includes a foam height adjustment valve for varying the level of water within the foam fractionation column.

26. The system of any one of claims 23, 24 and 25 that further includes a flocculating column.

27. The system of any one of claim 23 to claim 26 that further includes a pH sensor and pH adjustment means.

28. The system of any one of claim 23 to claim 27 that further includes one or more treatment agent injection means.

29. The system of any one of claim 23 to claim 28 that further includes one or more water storage tanks.

30. The system of any one of claim 24 to claim 29 wherein the foam fractionation column comprises:
(i) a column body;
(ii) a column base;
(iii) a first water inlet located around the top of the column body;
(iv) a second water inlet located in the column base and including gas injecting means for introducing gas into said second water inlet;
(v) a water outlet located in the column base;
(vi) a foam formation zone located at the top of the fractionating column above the first water inlet; and
(vii) a foam compression zone located above the foam formation zone comprising a frusto-conical section and a foam outlet;
wherein the length of the column body is between 150-200% greater than the length of the column base, the diameter of the column base is at least 50% larger than the diameter of the column body and the base and body of the column are interconnected by a frusto-conical section, the edges of the frusto-conical section sloped at 45-80 degrees.

31. The system of claim 30 wherein the edges of the frusto-conical section are sloped at around 60 degrees.

32. The system of claim 25 wherein the foam height adjustment valve comprises:
(i) a housing with a central bore positioned in the housing;
(ii) one or more bushes positioned in the housing;
(iii) a valve stem threadably engaged with the bushes;
(iv) a handle located at a proximal end of the stem;
(v) a valve located at a distal end of the stem; and
(vi) a least one or more air pathways located in the bushes and adapted to provide communication between external air and an internal space of a conduit to which the valve assembly is attached.

33. A foam fractionation column comprising:
(i) a column body;
(ii) a column base;
(iii) a first water inlet located around the top of the column body;
(iv) a second water inlet located in the column base and including gas injecting means for introducing gas into said second water inlet;
(v) a water outlet located in the column base;
(vi) a foam formation zone located at the top of the fractionating column above the first water inlet; and
(vii) a foam compression zone located above the foam formation zone comprising a frusto-conical section and a foam outlet;
wherein the length of the column body is between 150-200% greater than the length of the column base; the diameter of the column base is at least 50% larger than the diameter of the column body and the base and body of the column are interconnected by a frusto-conical section, the edges of the frusto-conical section sloped at 45-80 degrees.

34. The foam fractionation column of claim 33 wherein the edges of the frusto-conical section are sloped at around 60 degrees.

35. The foam fractionation column of claim 33 and claim 34 further including a foam removal apparatus, the foam removal apparatus comprising:
(i) a discharge conduit in communication with the foam outlet of the foam fractionation column;
(ii) a spray nozzle housed within the conduit, the spray nozzle in liquid communication with a motive flow source; and
(iii) at least one or more air pathways located in the conduit to provide communication between external air and an internal space of the conduit.

36. A valve assembly for varying the level of water within a foam fractionation column, the valve assembly comprising:
(i) a housing with a central bore positioned in the housing;
(ii) one or more bushes positioned in the housing;
(iii) a valve stem threadably engaged with the bushes;
(iv) a handle located at a proximal end of the stem;
(v) a valve located at a distal end of the stem; and
(vi) a least one or more air pathways located in the bushes and adapted to provide communication between external air and an internal space of a conduit to which the valve assembly is attached.

37. The valve assembly of claim 36 wherein the one or more bushes comprise two spaced bushes.

38. The valve assembly of claim 36 or claim 37 in liquid communication with the foam fractionation column of claim 33.
